(19) United States
(12) Patent Application Publication
(10) Pub. No.: US 2026/0301691 A1
(43) Pub. Date: Oct. 1, 2026

(54) DISPLAY DEVICE

(71) Applicant: LG Display Co., Ltd., Seoul (KR)

(72) Inventor: Woo Kyu SANG, Paju-si (KR)

(21) Appl. No.: 19/635,576

(22) Filed: Mar. 31, 2026

(30) Foreign Application Priority Data
Mar. 31, 2025 (KR) 10-2025-0041543

(51) Int. Cl. G09G 3/3266; G09G 3/32; G09G 3/3275

(52) U.S. Cl. CPC G09G 3/3266; G09G 3/32; G09G 3/3275; G09G 2300/0408; G09G 2300/0814; G09G 2310/0245; G09G 2310/0267; G09G 2310/0275; G09G 2330/023

(57) ABSTRACT

A display device includes a display panel in which data lines, gate lines, power lines, and pixels are disposed; a data driver electrically connected to the data lines; a gate driver electrically connected to the gate lines; a timing controller configured to control the data driver and the gate driver; and a signal selector disposed between the timing controller and the gate driver, wherein the timing controller determines a refresh rate of an input image and controls positions of the pixels to be varied for each frame period, and the signal selector selects whether to apply a start signal provided from the timing controller, and controls the gate driver to output a scan signal to a first refresh rate area to which a refresh rate higher than or equal to a reference refresh rate is applied, during a same one horizontal period (1H) within the frame period.

### CROSS-REFERENCE TO RELATED APPLICATION

Pursuant to 35 U.S.C. § 119(a), this application claims the benefit of an earlier filing date and right of priority to Korean Patent Application No. 2025-0041543, filed on Mar. 31, 2025, the disclosure of which is incorporated herein by reference in its entirety.

### TECHNICAL FIELD

The present disclosure relates to a display device.

### BACKGROUND

Various flat panel display devices, such as a liquid crystal display device and an electroluminescent display device have been developed. An electroluminescent display device may use light-emitting elements arranged in each pixel to emit light by itself without a backlight, thereby displaying an input image. The light-emitting elements of the electroluminescent display device may be divided into an organic light-emitting element and an inorganic light-emitting element depending on a material of a light-emitting layer. In an active matrix-type organic light-emitting display device, an organic light-emitting diode (hereinafter referred to as an “OLED”) that emits light by itself is disposed in each pixel, thereby providing advantages of a fast response speed, high luminous efficiency, high luminance, and a wide viewing angle, and having excellent contrast ratio and color reproduction because black grayscale levels are representable as perfect black.

### SUMMARY

A display device according to one implementation includes: a display panel in which a plurality of data lines, a plurality of gate lines, a plurality of power lines, and a plurality of pixels are disposed; a data driver circuit electrically connected to the data lines; a gate driver circuit electrically connected to the gate lines; a timing controller circuit configured to control the data driver circuit and the gate driver circuit; and a signal selector circuit disposed between the timing controller circuit and the gate driver circuit, wherein the timing controller circuit determines a refresh rate of an input image and controls positions of the plurality of pixels to be varied for each frame period, and the signal selector circuit selects whether to apply a start signal provided from the timing controller circuit, and controls the gate driver circuit to output a scan signal to a first refresh rate area to which a refresh rate higher than or equal to a reference refresh rate is applied, during the same one horizontal period (1H) within the frame period.

A display device according to another implementation includes: a display panel in which a plurality of data lines, a plurality of gate lines, a plurality of power lines, and a plurality of pixels are disposed; a data driver circuit electrically connected to the data lines; a gate driver circuit electrically connected to the gate lines; a timing controller circuit configured to control the data driver circuit and the gate driver circuit; and a signal selector circuit disposed between the gate lines and the plurality of pixels, wherein the timing controller circuit determines a refresh rate of an input image and controls positions of the plurality of pixels to be varied for each frame period, and the signal selector circuit selects whether to output a scan signal provided from the gate driver circuit and performs control such that the scan signal is output to a first refresh rate area to which a refresh rate higher than or equal to a reference refresh rate is applied, during the same one horizontal period (1H) within the frame period.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with implementations of the disclosure.

It is to be understood that both the foregoing general description and the following detailed description are examples and explanatory and are intended to provide further explanation of the inventive concepts as claimed.

### BRIEF DESCRIPTION OF THE DRAWINGS

FIG. 1 is a diagram illustrating an example display device according to one implementation of the present disclosure.

FIG. 2 is a circuit diagram illustrating an example pixel circuit according to one implementation of the present disclosure.

FIG. 3 is a waveform diagram illustrating example driving signals applied to the pixel circuit illustrated in FIG. 2 during a refresh frame period and a skip frame period.

FIG. 4 is a circuit diagram illustrating an example pixel circuit according to another implementation of the present disclosure.

FIG. 5 is a waveform diagram illustrating example driving signals applied to the pixel circuit illustrated in FIG. 4 during a refresh frame period and a skip frame period.

FIG. 6 is a diagram illustrating an example gate driver that outputs gate signals to be applied to the pixel circuits illustrated in FIGS. 2 and 4.

FIG. 7 is a waveform diagram illustrating example clocks and start signals input to shift registers illustrated in FIG. 6.

FIG. 8 is a diagram illustrating an example first gate driver that outputs gate signals applied to the pixel circuits illustrated in FIGS. 2 and 4.

FIG. 9 is a waveform diagram illustrating example driving signals applied to the first gate driver illustrated in FIG. 8.

FIG. 10 is a diagram illustrating an example second gate driver configured to output gate signals applied to the pixel circuits illustrated in FIGS. 2 and 4.

FIG. 11 is a waveform diagram illustrating example driving signals applied to the second gate driver illustrated in FIG. 10.

FIG. 12 is a diagram illustrating an example of the display panel driven at multiple frequencies within one frame period.

FIG. 13 is a diagram illustrating an example of the display panel driven at multiple frequencies based on a plurality of D-ICs within one frame period.

FIG. 14 is a diagram illustrating an example of the signal selector according to the implementation of the present disclosure.

FIG. 15 is a diagram illustrating another example of the signal selector according to the implementation of the present disclosure.

FIGS. 16-18 are waveform diagrams illustrating example driving signals driven during the refresh frame period and the skip frame period in accordance with operation of the signal selector according to the implementation of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Display devices can support a variable refresh rate (VRR). However, in scenarios where an image requires high refresh rate (HRR) driving, a scan signal is typically applied on a frame-by-frame basis, which requires data to be input. This can create limitations in power-saving techniques, such as turning off a source driver integrated circuit (source D-IC) or reducing a source amplifier current, and thus additional reduction in power consumption cannot be achieved.

Implementations of the present disclosure can provide a display device that supports a variable refresh rate (VRR).

Implementations of the present disclosure can provide a display device capable of reducing power consumption by turning on only data integrated circuits (D-ICs) that are associated with a sub-display area driven at a high refresh rate, and turning off D-ICs that are associated with a sub-display area driven at a low refresh rate.

Reference will now be made in detail to implementations of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed, with the exception of steps and/or operations necessarily occurring in a particular order. Like reference numerals designate like elements throughout. Names of the respective elements used in the following explanations may be selected only for convenience of writing the specification and may be thus different from those used in actual products.

The advantages and features of the present disclosure and methods for accomplishing the same will be more clearly understood from implementations described below with reference to the accompanying drawings. However, the present disclosure is not limited to the following implementations but may be implemented in various different forms. Rather, the present implementations will make the disclosure of the present disclosure complete and allow those skilled in the art to completely comprehend the scope of the present disclosure.

The shapes, sizes, ratios, angles, numbers, and the like illustrated in the accompanying drawings for describing the implementations of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

Any implementation described herein as an “example” is not necessarily to be construed as preferred or advantageous over other implementations.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

Also, when an element or layer is “connected,” “coupled,” or “adhered” to another element or layer denotes that the element or layer can not only be directly connected or adhered to another element or layer, but also be indirectly connected or adhered to another element or layer with one or more intervening elements or layers “disposed,” or “interposed” between the elements or layers, unless otherwise specified. It should be understood to mean that elements may be so disposed to directly contact each other, or may be so disposed without directly contacting each other.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example implementations belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these implementations may be provided so that this disclosure may be sufficiently thorough and complete to assist those skilled in the art to fully understand the scope of the present disclosure. Furthermore, the present disclosure is only defined by scopes of claims.

The following implementations can be partially or entirely bonded to or combined with each other and can be linked and operated in technically various ways. The implementations can be carried out independently of or in association with each other.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low-temperature poly silicon TFT (LTPS TFT) including a low-temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage, and the gate-off voltage may be a gate low voltage VGL. In the case of a p-channel transistor, the gate-on voltage may be the gate low voltage VGL, and the gate-off voltage may be the gate high voltage.

Hereinafter, various implementations of the present disclosure will be described in detail with reference to the accompanying drawings.

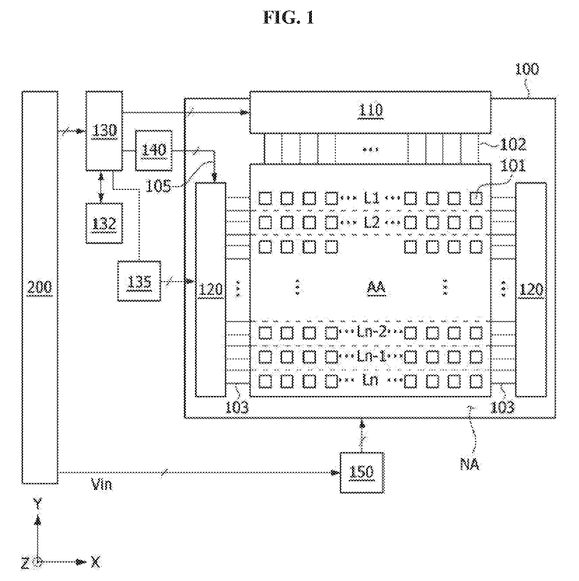

FIG. 1 is a diagram illustrating a display device according to one implementation of the present disclosure.

Referring to FIG. 1, the display device according to the implementation of the present disclosure includes a display panel 100, display panel driving circuits (e.g., data driver 110 and gate drivers 120) for writing pixel data to pixels 101 of the display panel 100, a power generating unit 150 configured to generate power required to drive the pixels 101 and the display panel driving circuits (e.g., data driver 110 and gate drivers 120), and the like.

The display panel 100 may be a panel having a rectangular structure with a width in an X-axis direction, a length in a Y-axis direction, and a thickness in a Z-axis direction, but the present disclosure is not limited thereto. A screen of the display panel 100 may include a display area AA and a non-display area outside the display area AA. The display area AA of the display panel 100 includes a pixel array configured to display an input image. The pixel array includes a plurality of data lines 102, a plurality of gate lines 103 crossing the data lines 102, and the pixels arranged in a matrix form. The display panel 100 may further include power lines commonly connected to two or more pixels. The power lines may be commonly connected to pixel circuits and may supply voltages required to drive the pixels 101 to the pixels 101.

The data lines 102 are disposed in the form of long wirings extending in the Y-axis direction of the display panel 100 and are electrically connected to data channels of a data driver 110. The gate lines 103 are disposed in the form of long wirings extending in the X-axis direction of the display panel 100 to cross the data lines 102 and are electrically connected to output terminals of gate drivers 120.

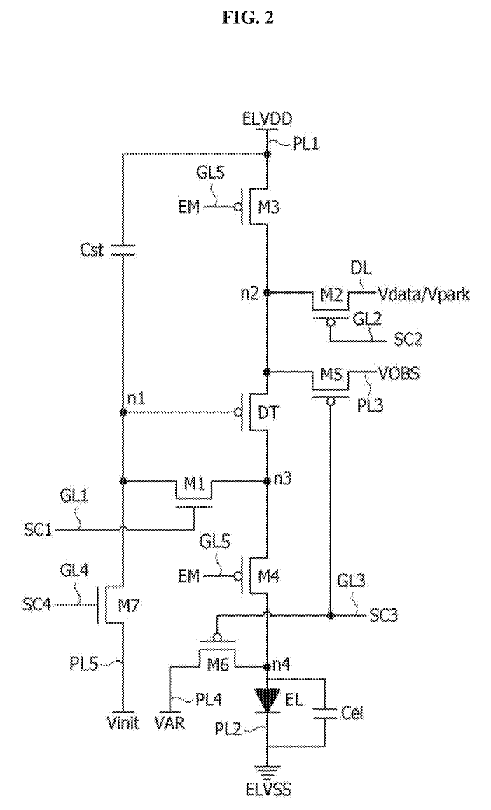

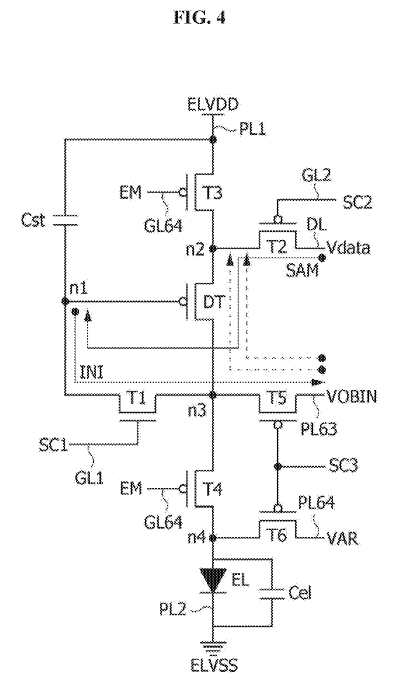

Each of the pixels 101 may be divided into a red sub-pixel, a green sub-pixel, and a blue sub-pixel for color implementation. Each of the pixels may further include a white sub-pixel. Each of the sub-pixels includes a pixel circuit for driving a light-emitting element. Each pixel circuit is connected to the data lines, the gate lines, and the power lines. The pixel circuit may be implemented as circuits illustrated in FIGS. 2 and 4, but the present disclosure is not limited thereto.

The pixel array includes a plurality of pixel lines L1 to Ln. Each of the pixel lines L1 to Ln includes pixels disposed in one line extending in the X-axis direction in the pixel array of the display panel 100. The pixels disposed in one pixel line share a gate line corresponding to the pixel line among the gate lines 103. Sub-pixels disposed in a data line direction (the Y-axis direction) share the same data line 102. One horizontal period 1H may be a time obtained by dividing one frame period by a total number of the pixel lines L1 to Ln.

The display panel 100 may be implemented as a non-transmissive display panel or a transmissive display panel. The transmissive display panel may be applied to a transparent display device in which an image is displayed on a screen and a real object in a background is visible. The display panel 100 may be manufactured as a flexible display panel.

The power generating unit 150 adjusts a level of a DC input voltage Vin applied from a host system 200 and outputs a first voltage V1 required to drive the pixel array and the display panel driving circuits of the display panel 100. The power generating unit 150 may include a DC-DC converter. The DC-DC converter may include a charge pump, a regulator, a buck converter, a boost converter, and the like. The power generating unit 150 may output, through the DC-DC converter, a gamma reference voltage, a gate high voltage, a gate low voltage, a pixel driving voltage, a pixel ground voltage, a pixel compensation voltage, an integrated circuit (IC) driving voltage, and the like. Voltages output from the power generating unit 150 may be constant voltages (or DC voltages), but the present disclosure is not limited thereto.

In some implementations, the gamma reference voltage is supplied to the data driver 110. A dynamic range of data voltages output from the data driver 110 is determined according to a voltage range of the gamma reference voltage. The dynamic range of the data voltages has a voltage range between a highest gray-level voltage and a lowest gray-level voltage.

In some implementations, the gate high voltage and the gate low voltage are supplied to a level shifter 140 and the gate drivers 120. Voltages such as the pixel driving voltage and the pixel ground voltage are supplied to the pixels 101. The IC driving voltage is a driving voltage of a drive IC in which circuits such as a timing controller 130 (or timing controller circuit) and the data driver 110 (or data driver circuit) are integrated.

In some implementations, the power generating unit 150 may adjust an output voltage under control of the timing controller 130. For example, the power generating unit 150 may be connected to the timing controller 130 through a wiring via which a signal is transmitted through a serial interface such as inter-integrated circuit (I2C) or serial peripheral interface bus (SPI).

In some implementations, the timing controller 130 is implemented as an application-specific integrated circuit (ASIC), and the power generating unit 150 may be implemented as a power IC such as a power management integrated circuit (PMIC) or electronics integrated circuit (ELIC). A signal transmission speed of I2C is up to 400 kbps, and a transmission speed of SPI is about 10 to 100 Mbps.

The display panel driving circuits write pixel data of an input image to the pixels of the display panel 100 under control of the timing controller 130. For example, the display panel driving circuits can include the data driver 110 and the gate drivers 120. The display panel driving circuits may further include a de-multiplexer (DEMUX) disposed between the data driver 110 and the data lines 102, but the present disclosure is not limited thereto. When the de-multiplexers are disposed between output terminals of the data driver 110 and the data lines 102, the number of channels (or the number of output terminals) of the data driver 110 electrically connected to the data lines 102 may be reduced.

In some implementations, touch sensors for sensing a touch input may be disposed on the display panel 100. The touch sensors may be disposed on the display panel 100 in an on-cell type or an add-on type, or may be implemented as in-cell type touch sensors embedded in the pixel array.

In such scenarios, the display panel driving circuits (e.g., data driver 110 and gate drivers 120) may further include a touch sensor driver for driving the touch sensors. The touch sensor driver is omitted in FIG. 1. The data driver 110 and the touch sensor driver may be integrated into a single drive IC.

The data driver 110 is electrically connected to the data lines 102 and outputs a data voltage corresponding to pixel data of an input image. Each of the channels of the data driver 110 receives pixel data of an input image, which is received as a digital signal from the timing controller 130, and outputs a data voltage.

In some implementations, the channels of the data driver 110 may output data voltages of pixel data by converting pixel data of an input image received from the timing controller 130 into gamma compensation voltages using a digital-to-analog converter (DAC). The DAC of the data driver 110 is formed separately from a DAC of the power generating unit 150. The data driver 110 may divide the gamma reference voltage input from the power generating unit 150 into gamma compensation voltages having different voltage levels for respective gray levels by using a voltage divider circuit (or a voltage dividing circuit). The gamma compensation voltages are provided to the DAC of the data driver 110. The data voltages are output through output buffers from the respective channels of the data driver 110.

The data driver 110 may include one or more data integrated circuits (D-ICs). For example, the one or more D-ICs may include n D-ICs, arranged as a first D-IC to an n^{th} D-IC. Each of the first to n^{th} D-ICs may be electrically connected to the data lines 102 and may output data voltages corresponding to pixel data of an input image. Each of the channels of the first to n^{th} D-ICs may receive pixel data of the input image, which is received as a digital signal from the timing controller 130, and may output a data voltage.

The gate driver 120 may be disposed in at least one non-display area NA on at least one of left and right sides outside the display area AA of the display panel 100, or at least a portion of the gate driver 120 may be disposed within the display area AA. The gate drivers 120 may be disposed in non-display areas NA on both sides of the display panel 100 with the display area AA interposed therebetween and may supply pulses of gate signals to each of the gate lines 103 in a double-feeding manner from both sides thereof.

The gate driver 120 sequentially outputs the pulses of gate signals to the gate lines 103 under control of the timing controller 130. The gate driver 120 may sequentially supply the pulses of gate signals to the gate lines 103 by shifting the pulses of gate signals using a shift register or an edge trigger. The gate driver 120 may include a plurality of gate drivers. Each of the gate drivers may be implemented as a shift register or an edge trigger.

Gate signals for driving the pixel circuit may include a first scan signal, a second scan signal, a third scan signal, and an emission control signal (hereinafter referred to as an EM signal). In this case, the gate driver 120 may include a plurality of gate drivers.

A signal selector 135 (or signal selector circuit) is disposed between the timing controller 130 and the gate driver 120. The signal selector 135 may select whether a start signal VST provided from the timing controller 130 is applied. The signal selector 135 may include one or more switch elements (not shown). For example, each of the one or more switch elements (not shown) may operate, under control of the timing controller 130, such that the start signal VST is supplied to the gate driver 120 or the start signal VST is not supplied to the gate driver 120.

The signal selector 135 may select whether the start signal VST provided from the timing controller 130 is applied and may control the gate driver 120 to output scan signals to a first area to which a refresh rate higher than a reference refresh rate is applied in the same one horizontal period 1H within a frame period. The signal selector 135 may select whether the start signal VST provided from the timing controller 130 is applied and may control the gate driver 120 so as not to output the scan signals to the remaining areas other than the first area, to which a refresh rate lower than the reference refresh rate is applied in the same one horizontal period 1H within the frame period.

The timing controller 130 receives, from the host system 200, digital video data of an input image and timing signals synchronized with the digital video data. The timing signals may include a vertical synchronization signal Vsync, a horizontal synchronization signal Hsync, a data enable signal DE, and the like. The vertical synchronization signal Vsync and the horizontal synchronization signal Hsync may be omitted because a vertical period and a horizontal period can be identified by counting the data enable signal DE. The horizontal synchronization signal Hsync and the data enable signal DE each have a period equal to one horizontal period 1H. During the one horizontal period 1H, data voltages of pixel data may be simultaneously charged to sub-pixels disposed in one pixel line, thereby writing the pixel data to the sub-pixels.

The timing controller 130 generates, based on the timing signals Vsync, Hsync, and DE received from the host system 200, a data timing control signal for controlling an operation timing of the data driver 110 and a gate timing control signal for controlling an operation timing of the gate driver 120. The timing controller 130 synchronizes the data driver 110 and the gate driver 120 by controlling the operation timings of the display panel driving circuits.

The gate timing control signal output from the timing controller 130 may be input to the shift register and/or the edge trigger of the gate driver 120 through the level shifter 140. The level shifter 140 may convert the gate timing control signal received from the timing controller 130 through clock lines 105 into a swing range between the gate high voltage and the gate low voltage and may provide the converted signal to the gate driver 120. The gate timing control signal output from the level shifter 140 may include a start signal, a clock, and the like, but the present disclosure is not limited thereto. The gate driver 120 may output pulses of gate signals for writing pixel data to the sub-pixels during a display period in response to the gate timing control signal input from the level shifter 140.

In some implementations, the display panel driving circuits (e.g., data driver 110 and gate drivers 120) may drive the pixels 101 at a variable refresh rate under control of the timing controller 130. For example, the timing controller 130 may reduce a refresh rate of an image displayed on the display panel 100 according to a frequency of an input image or based on a result of analyzing the input image. This can help reduce power consumption of the display device and improve image quality. As examples, the variable refresh rate may vary a refresh driving frequency of the pixels to 1 Hz, 30 Hz, 60 Hz, 120 Hz, 144 Hz, 165 Hz, 240 Hz, or the like, but the present disclosure is not limited thereto.

The refresh driving frequency is a pixel driving frequency at which pixel data is written at a frame rate of frames per second (FPS) corresponding to the variable refresh rate. On the other hand, a skip driving frequency is a pixel driving frequency at which new pixel data is not written and data voltages of pixel data charged during a previous refresh frame are maintained. When the pixels are skip-driven, no pixel initialization or data writing is performed, and thus power consumption in the display panel 100 and the display panel driving circuits (e.g., data driver 110 and gate drivers 120) during skip driving is significantly lower than that during refresh driving.

The variable refresh rate is a refresh rate at which frames of an image are refreshed on a screen of the display panel 100 that is varied in real time instead of being maintained at a fixed value. When displaying an image of content, such as a game or an animation, on the display panel 100, the display panel driving circuits (e.g., data driver 110 and gate drivers 120) may reduce screen tearing or stuttering by adjusting a refresh driving frequency at which the pixels 101 are driven according to FPS of the image under control of the timing controller 130.

In some implementations, the pixels charge data voltages of pixel data according to FPS that vary in real time according to the variable refresh rate. A unit of the variable refresh rate is hertz (Hz). When the refresh rate is 60 Hz, pixel data is written to the pixels in each frame period at 60 FPS, and when the refresh rate increases to 120 Hz, pixel data is written to the pixels in each frame period at 120 FPS. In a display device supporting the variable refresh rate, a refresh driving frequency of pixels for writing pixel data to the pixels varies according to the variable refresh rate.

The timing controller 130 may determine a refresh rate of an input image in real time by counting the input timing signals Vsync, Hsync, and DE with the clock. The vertical synchronization signal Vsync defines one frame period. One pulse period of each of the horizontal synchronization signal Hsync and the data enable signal DE is one horizontal period 1H. The data enable signal DE defines a valid data period during which pixel data of an input image is present.

In some implementations, the timing controller 130 may determine a refresh rate of an input image and may control the sizes and positions of a plurality of pixels to be varied for each frame period.

As an example, when the timing controller 130 determines that the refresh rate of the input image is higher than or equal to the reference refresh rate, the timing controller 130 may provide a first signal to the signal selector 135. When the timing controller 130 determines that the refresh rate of the input image is lower than the reference refresh rate, the timing controller 130 may provide a second signal to the signal selector 135.

For example, when the first signal is supplied from the timing controller 130, the signal selector may be controlled to supply the start signal to the gate driver, and when the second signal is supplied from the timing controller 130, the signal selector may be controlled so as not to supply the start signal to the gate driver.

In some implementations, the display panel driving circuits (e.g., data driver 110 and gate drivers 120) may, under control of the timing controller 130, lower a refresh rate of the pixels 101 when a still image is input for a threshold time or longer, which can help reduce power consumption of the display device. Conversely, the display panel driving circuits (e.g., data driver 110 and gate drivers 120) may, under control of the timing controller 130, may increase a refresh driving frequency of the pixels 101 according to a refresh rate of the input image, which can help achieve image quality optimized for content of an input image. For example, the refresh rate of the display device may be lowered when the display device operates in a standby mode or in response to a user command. In addition, the refresh rate may be lowered in an always on display (AOD) screen. The AOD screen may be a partial pixel area of the display area AA in which various information, for example, battery remaining amount and time, is displayed in the standby mode.

The host system 200 may convert a resolution of an image signal from a video source to match a resolution of the display panel 100 and may transmit the image signal to the timing controller 130 together with the timing signals.

A memory 132 may store driving setting timing information of the display panel driving circuits (e.g., data driver 110 and gate drivers 120), program codes of a compensation algorithm for improving image quality, and the like. The memory 132 may include a non-volatile memory and a volatile memory. The non-volatile memory is a readable and writable memory and may include one or more of a NAND flash memory, a NOR flash memory, and an electrically erasable programmable read-only memory (EEPROM). The NAND flash memory may be a single level cell (SLC) type. The volatile memory may include one or more of a dynamic random-access memory (DRAM), a static random-access memory (SRAM), a synchronous dynamic random-access memory (SDRAM), and a double data rate synchronous dynamic-random access memory (DDR SDRAM).

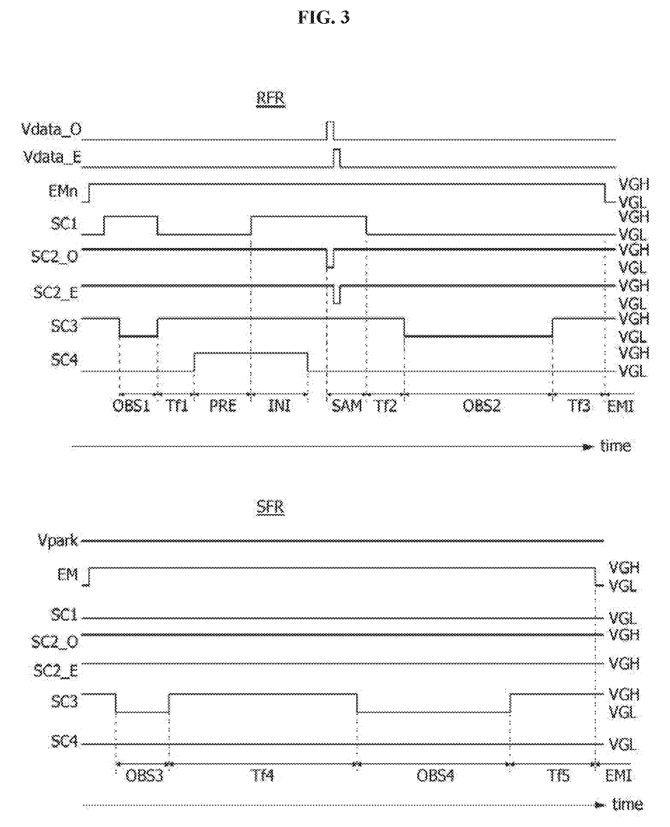

Under control of the timing controller 130, the display panel driving circuits (e.g., data driver 110 and gate drivers 120) may drive the pixels at a high refresh rate or at a low refresh rate. In a frame period in which the pixels are driven at the high refresh rate, the pixels may receive refresh driving signals as illustrated in FIG. 3 and may charge data voltages of pixel data. In a frame period in which the pixels are driven at the low refresh rate, the pixels may receive skip driving signals as illustrated in FIG. 3 and may maintain emission with data voltages charged in a previous refresh frame.

FIG. 2 is a circuit diagram illustrating a pixel circuit according to one implementation of the present disclosure. FIG. 3 is a waveform diagram illustrating driving signals applied to the pixel circuit illustrated in FIG. 2 during a refresh frame period and a skip frame period. In FIG. 3, a second scan signal SC2_O is a gate signal synchronized with an odd-numbered data voltage Vdata_O and applied to sub-pixels of odd-numbered pixel lines. A second scan signal SC2_E is a gate signal synchronized with an even-numbered data voltage Vdata_E and applied to sub-pixels of even-numbered pixel lines.

Referring to FIGS. 2 and 3, the pixel circuit includes a light-emitting element EL, a driving element DT configured to drive the light-emitting element EL, a plurality of switch elements M1 to M7, and a capacitor Cst.

Each of first and seventh switch elements M1 and M7 may be implemented as an n-channel oxide thin-film transistor (TFT). The first and seventh switch elements M1 and M7 are turned on in response to a gate high voltage VGH of corresponding gate signals as illustrated in FIG. 3, whereas the first and seventh switch elements M1 and M7 are turned off in response to a gate low voltage VGL. Each of the driving element DT and the second, third, fourth, fifth, and sixth switch elements M2, M3, M4, M5, and M6 may be implemented as a p-channel low-temperature polysilicon (LTPS) TFT. The second, third, fourth, fifth, and sixth switch elements M2, M3, M4, M5, and M6 are turned on in response to the gate low voltage VGL of corresponding gate signals and are turned off in response to the gate high voltage VGH.

The pixel circuit is connected to a data line DL to which the data voltage Vdata of pixel data and a third compensation voltage Vpark are applied, and to gate lines GL1, GL2, GL3, GL4, and GL5 to which gate signals SC1, SC2, SC3, SC4, and EM are applied. The data voltage Vdata is applied to the data line DL during a sampling period in a refresh frame period.

A pixel driving voltage ELVDD and a pixel ground voltage ELVSS are set to voltages at which the driving element DT operates in a saturation region.

The gate signals SC1, SC2, SC3, SC4, and EM include pulses swinging between the gate high voltage VGH and the gate low voltage VGL.

The driving element DT includes a gate electrode connected to a first node n1, a first electrode connected to a second node n2, and a second electrode connected to a third node n3. The capacitor Cst is connected between a first power line PL1 to which the pixel driving voltage ELVDD is applied and the first node n1, and suppresses variations in a gate-to-source voltage Vgs of the driving element DT.

The light-emitting element EL includes an anode connected to a fourth node n4 and a cathode connected to a second power line PL2 to which the pixel ground voltage ELVSS is applied. The light-emitting element EL may be implemented as an organic light-emitting diode (OLED). The OLED includes a parasitic capacitance Cel due to a stacked structure thereof.

The first switch element M1 is connected between the first node n1 and the third node n3 and is turned on in response to the gate high voltage VGH of a first scan signal SC1. When the first switch element M1 is turned on, the first node n1 is electrically connected to the third node n3.

The second switch element M2 is connected between the data line DL and a second node n2 and is turned on in response to the gate low voltage VGL of a second scan signal SC2. When the second switch element M2 is turned on, the data line DL is electrically connected to the second node n2.

The third switch element M3 is connected between the first power line PL1 and the second node n2 and is turned on in response to the gate low voltage VGL of an EM signal EM. When the third switch element M3 is turned on, the pixel driving voltage ELVDD is applied to the second node n2.

The fourth switch element M4 is connected between the third node n3 and the fourth node n4 and is turned on in response to the gate low voltage VGL of the EM signal EM. When the fourth switch element M4 is turned on, the third node n3 is electrically connected to the fourth node n4.

The fifth switch element M5 is connected between the second node n2 and a third power line PL3 to which a first compensation voltage VOBS is applied and is turned on in response to the gate low voltage VGL of a third scan signal SC3. When the fifth switch element M5 is turned on, the first compensation voltage VOBS is applied to the second node n2.

The sixth switch element M6 is connected between the fourth node n4 and a fourth power line PL4 to which a second compensation voltage VAR is applied and is turned on in response to the gate low voltage VGL of the third scan signal SC3. When the sixth switch element M6 is turned on, the second compensation voltage VAR is applied to the anode of the light-emitting element EL connected to the fourth node n4.

A seventh switch element M7 is connected between the first node n1 and a fifth power line PL5 to which an initialization voltage Vinit is applied and is turned on in response to the gate high voltage VGH of a fourth scan signal SC4. When the seventh switch element M7 is turned on, the initialization voltage Vinit is applied to the capacitor Cst connected to the first node n1 and to the gate electrode of the driving element DT.

The pixel circuit may receive refresh driving signals during a refresh frame period RFR and may charge a data voltage of pixel data, thereby being driven at a refresh driving frequency. The refresh frame period RFR may be divided into a first on-bias period OBS1, a first initialization period PRE, a second initialization period INI, a sampling period SAM, a second on-bias period OBS2, and an emission period EMI.

A first floating period Tf1 may be set between the first on-bias period OBS1 and the first initialization period PRE. A second floating period Tf2 may be set between the sampling period SAM and the second on-bias period OBS2. A third floating period Tf3 may be set between the second on-bias period OBS2 and the emission period EMI. During the floating periods Tf1, Tf2, and Tf3, all of the first to seventh switch elements M1 to M7 are in an off state so that the first to fourth nodes n1, n2, n3, and n4 are floated and maintain previous states thereof.

During the first on-bias period OBS1, the fifth and sixth switch elements M5 and M6 are turned on so that the first compensation voltage VOBS is applied to the second node n2 and the second compensation voltage VAR is applied to the fourth node n4. During the first on-bias period OBS1, the first switch element M1 is turned on so that the first node n1 is electrically connected to the third node n3.

During the first initialization period PRE, the seventh switch element M7 is turned on so that the initialization voltage Vinit is applied to the first node n1. During the first initialization period PRE, the light-emitting element EL is in an off state and thus does not emit light. During the second initialization period INI, the first and seventh switch elements M1 and M7 are turned on so that the initialization voltage Vinit is applied to the first and third nodes n1 and n3, and the initialization voltage Vinit is also applied to the second node n2 through the driving element DT that remains in an on state.

During the sampling period SAM, the second switch element M2 is turned on in response to the gate low voltage VGL of the second scan signal SC2. At this point, the data voltage Vdata is applied to the second node n2, and the data voltage Vdata is also applied to the first and third nodes n1 and n3 through the driving element DT that is in the on state. During the second on-bias period OBS2, the fifth and sixth switch elements M5 and M6 are turned on so that the first compensation voltage VOBS is applied to the second node n2 and the second compensation voltage VAR is applied to the fourth node n4.

During the emission period EMI of the refresh frame period RFR, the third and fourth switch elements M3 and M4 are turned on in response to the gate low voltage VGL of the EM signal EM. During the emission period EMI, a current path is formed between the pixel driving voltage ELVDD and the light-emitting element EL through the third and fourth switch elements M3 and M4 so that the light-emitting element EL may emit light at a luminance corresponding to a gray level of pixel data.

During a skip frame period SFR, the pixel circuit may be driven at a skip driving frequency lower than the refresh driving frequency by receiving skip driving signals. The skip frame period SFR may be divided into a third on-bias period OBS3, a fourth on-bias period OBS4, and an emission period EMI. A fourth floating period Tf4 may be set between the third on-bias period OBS3 and the fourth on-bias period OBS4. A fifth floating period Tf5 may be set between the fourth on-bias period OBS4 and the emission period EMI. During the fourth and fifth floating periods Tf4 and Tf5, all of the first to seventh switch elements M1 to M7 are in an off state so that the first to fourth nodes n1, n2, n3, and n4 are floated.

The data driver 110 does not output the data voltage Vdata during the skip frame period SFR. During the skip frame period SFR, the third compensation voltage Vpark is applied to the data lines DL. During the skip frame period SFR, voltages of the first and fourth scan signals SC1 and SC4 are maintained at the gate low voltage VGL, and voltages of the second scan signals SC2_O and SC2_E are maintained at the gate high voltage VGH. During the skip frame period SFR, the first, second, and seventh switch elements M1, M2, and M7 remain in the off state. The gate driver 120 does not output pulses of the scan signals SC1, SC2_O, SC2_E, and SC4, other than the third scan signal SC3, during the skip frame period SFR. During the skip frame period SFR, the pixel circuit may drive the light-emitting element EL by using a voltage of the capacitor Cst charged with the data voltage Vdata in a previous refresh frame period RFR.

During the third and fourth on-bias periods OBS3 and OBS4, the fifth and sixth switch elements M5 and M6 are turned on so that the first compensation voltage VOBS is applied to the second node n2 and the second compensation voltage VAR is applied to the fourth node n4.

During the emission period EMI of the skip frame period SFR, the third and fourth switch elements M3 and M4 are turned on in response to the gate low voltage VGL of the EM signal EM. During the emission period EMI, a current path is formed between the pixel driving voltage ELVDD and the light-emitting element EL through the third and fourth switch elements M3 and M4 so that the light-emitting element EL may emit light at a luminance corresponding to a gray level of pixel data.

During the skip frame period SFR, the pixels may emit light at luminance corresponding to gray levels of previously written pixel data. During the skip frame period SFR, power consumption of the data driver 110 and the gate driver 120 is significantly reduced. A skip driving frequency of the pixels 101 is significantly lower than the refresh driving frequency.

Accordingly, when the pixels 101 are driven at the variable refresh rate, power consumption of the display device may be reduced while an input image is reproduced normally on the display panel 100, and a voltage drop of a battery connected to the host system 200 may be reduced.

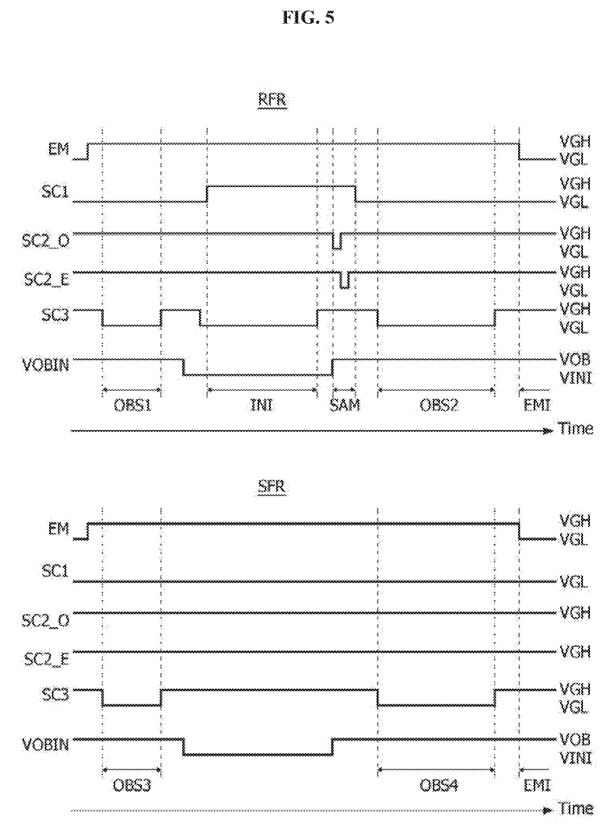

FIG. 4 is a circuit diagram illustrating a pixel circuit according to another implementation of the present disclosure. FIG. 5 is a waveform diagram illustrating driving signals applied to the pixel circuit illustrated in FIG. 4 during a refresh frame period and a skip frame period. In the present implementation, descriptions overlapping with those of the above-described implementation are omitted or may be briefly provided.

Referring to FIGS. 4 and 5, the pixel circuit includes a light-emitting element EL, a driving element DT configured to drive the light-emitting element EL, a plurality of switch elements T1 to T6, and a capacitor Cst. The pixel circuit is connected to a data line DL, gate lines GL1, GL2, GL63, and GL64, and power lines PL1, PL2, PL63, and PL64.

A first switch element T1 may be implemented as an n-channel oxide TFT. The first switch element T1 is turned on in response to a gate high voltage VGH of a first scan signal SC1 as illustrated in FIG. 5 and is turned off in response to a gate low voltage VGL. The driving element DT and second, third, fourth, fifth, and sixth switch elements T2, T3, T4, T5, and T6 may each be implemented as a p-channel LTPS TFT. The second, third, fourth, fifth, and sixth switch elements T2, T3, T4, T5, and T6 are turned on in response to the gate low voltage VGL of corresponding gate signals SC2, SC3, and EM in FIG. 5 and are turned off in response to the gate high voltage VGH.

The first switch element T1 is connected between a first node n1 and a third node n3, and as illustrated in FIG. 5, is turned on in response to the gate high voltage VGH of the first scan signal SC1 during an initialization period INI and a sampling period SAM of a refresh frame period RFR. When the first switch element T1 is turned on, the first node n1 is electrically connected to the third node n3.

The second switch element T2 is connected between the data line DL and a second node n2, and as illustrated in FIG. 5, is turned on in response to the gate low voltage VGL of a second scan signal SC2 during the sampling period SAM of the refresh frame period RFR. When the second switch element T2 is turned on, the data line DL is electrically connected to the second node n2.

The third switch element T3 is connected between a first power line PL1 and the second node n2, and as illustrated in FIG. 5, is turned on in response to the gate low voltage VGL of an EM signal EM during an emission period EMI. When the third switch element T3 is turned on, a pixel driving voltage ELVDD is applied to the second node n2.

The fourth switch element T4 is connected between the third node n3 and a fourth node n4, and as illustrated in FIG. 5, is turned on in response to the gate low voltage VGL of the EM signal EM during the emission period EMI. When the fourth switch element T4 is turned on, the third node n3 is electrically connected to the fourth node n4.

The fifth switch element T5 is connected between the third node n3 and a third power line PL63 to which a first compensation voltage VOBIN is applied and is turned on in response to the gate low voltage VGL of a third scan signal SC3. The first compensation voltage VOBIN is an AC voltage swinging between an on-bias voltage VOB and an initialization voltage VINI, as illustrated in FIG. 5. The on-bias voltage VOB is a voltage higher than the initialization voltage VINI. The on-bias voltage VOB is applied to the third node n3 through the fifth switch element T5 during on-bias periods OBS1 to OBS4. The initialization voltage VINI is applied to the third node n3 through the fifth switch element T5 during the initialization period INI. The on-bias voltage VOB corresponds to the first compensation voltage VOBS of the above-described implementation, and the initialization voltage VINI corresponds to the initialization voltage Vinit of the above-described implementation.

The sixth switch element T6 is connected between the fourth node n4 and a fourth power line PL64 and is turned on in response to the gate low voltage VGL of the third scan signal SC3. A second compensation voltage VAR is applied to the fourth node n4 through the sixth switch element T6 during the on-bias periods OBS1 to OBS4.

In the above-described pixel circuits, the switch elements M1, M7, and T1 connected to the capacitor Cst may be implemented as n-channel oxide TFTs having low leakage current, thereby reducing leakage current.

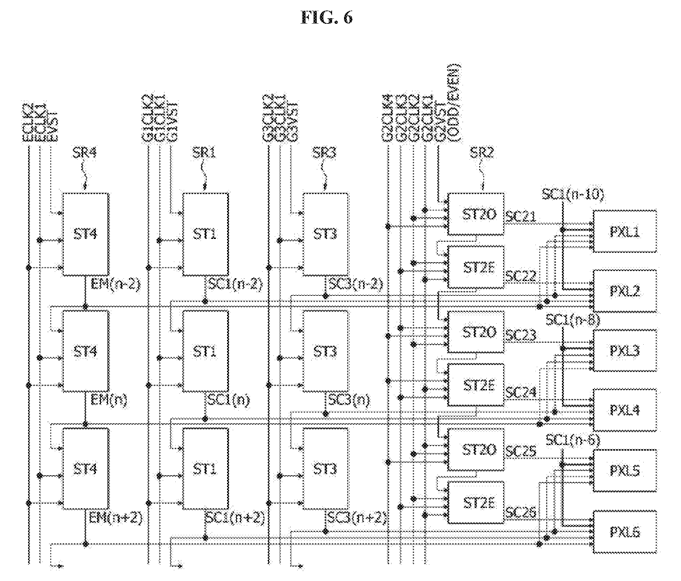

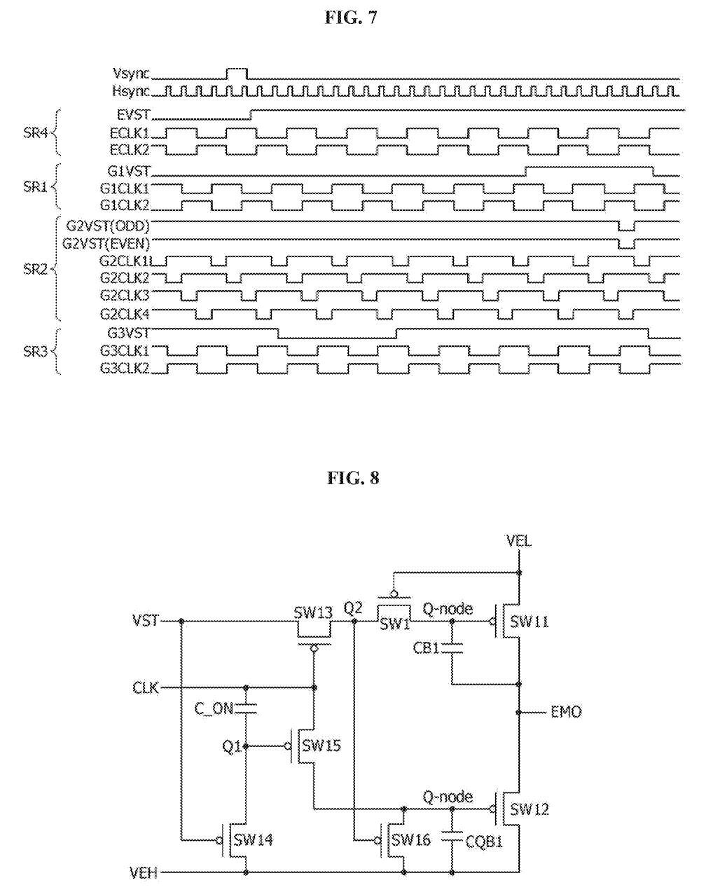

FIG. 6 is a diagram illustrating a gate driver that outputs gate signals to be applied to the pixel circuits illustrated in FIGS. 2 and 4. FIG. 7 is a waveform diagram illustrating clocks and start signals input to shift registers illustrated in FIG. 6.

Referring to FIGS. 1, 6 and 7, the gate driver 120 may include a first shift register SR1 configured to sequentially output pulses of the first scan signal SC1, a second shift register SR2 configured to sequentially output pulses of the second scan signal SC2, a third shift register SR3 configured to sequentially output pulses of the third scan signal SC3, and a fourth shift register SR4 configured to output pulses of the EM signal EM.

The first shift register SR1 includes a plurality of signal transfer units ST1 connected in a cascaded manner. The first shift register SR1 receives a start signal G1VST and clocks G1CLK1 and G1CLK2, and sequentially outputs pulses of the first scan signal SC1. The clocks G1CLK1 and G1CLK2 may include two or more shift clocks having different phases. A pulse width of the first scan signal SC1 is set to be wider than one horizontal period, as described with reference to FIG. 3 so that the first scan signal SC1 may be simultaneously applied to the pixels 101 disposed in the plurality of pixel lines. For example, a 1-1 scan signal SC1(n-10) and a 1-2 scan signal SC1(n-2) may be simultaneously applied to vertically adjacent first and second pixels PXL1 and PXL2. Subsequently, a 1-1 scan signal SC1(n-8) and a 1-2 scan signal SC1(n) may be simultaneously applied to vertically adjacent third and fourth pixels PXL3 and PXL4. Subsequently, a 1-1 scan signal SC1(n-6) and a 1-2 scan signal SC1(n+2) may be simultaneously applied to vertically adjacent fifth and sixth pixels PXL5 and PXL6.

In order to adjust a luminance difference between pixel lines, timings such as phases and pulse widths of pulses of second scan signals SC21, SC23, SC25, and SC2_O applied to odd-numbered pixel lines and pulses of second scan signals SC22, SC24, SC26, and SC2_E applied to even-numbered pixel lines may be differently adjusted.

To this end, the second shift register SR2 may include a plurality of odd-numbered shift registers ST2O configured to receive a first start signal G2VST(ODD) and first clocks G2CLK1 and G2CLK2 and to sequentially output pulses of the odd-numbered second scan signals SC21, SC23, SC25, and SC2_O, and a plurality of even-numbered shift registers ST2E configured to receive a second start signal G2VST(EVEN) and second clocks G2CLK3 and G2CLK4 and to sequentially output pulses of the even-numbered second scan signals SC22, SC24, SC26, and SC2_E.

A pulse width of each of the second scan signals SC21 to SC26, SC2_O, and SC2_E may be one horizontal period. The first clocks G2CLK1 and G2CLK2 may include two or more shift clocks having different phases. The second clocks G2CLK3 and G2CLK4 may include two or more shift clocks having different phases. A carry signal may be transmitted between adjacent odd-numbered and even-numbered signal transfer units ST2O and ST2E.

After a pulse of a 2-1 scan signal SC21 is applied to the first pixel PXL1, a pulse of a 2-2 scan signal SC22 may be applied to the second pixel PXL2. Subsequently, after a pulse of a 2-3 scan signal SC23 is applied to the third pixel PXL3, a pulse of a 2-4 scan signal SC24 may be applied to the fourth pixel PXL4. Subsequently, after a pulse of a 2-5 scan signal SC25 is applied to the fifth pixel PXL5, a pulse of a 2-6 scan signal SC26 may be applied to the sixth pixel PXL6.

The third shift register SR3 includes a plurality of signal transfer units ST3 connected in a cascaded manner. The third shift register SR3 receives a start signal G3VST and clocks G3CLK1 and G3CLK2, and sequentially outputs pulses of the third scan signal SC3. The clocks G3CLK1 and G3CLK2 may include two or more shift clocks having different phases. A pulse width of the third scan signal SC3 is set to be wider than one horizontal period, as described with reference to FIG. 3 so that the third scan signal SC3 may be simultaneously applied to the pixels 101 disposed in the plurality of pixel lines. For example, a pulse of a third scan signal SC3(n−2) may be simultaneously applied to the vertically adjacent first and second pixels PXL1 and PXL2. Subsequently, a pulse of a third scan signal SC3(n) may be simultaneously applied to the vertically adjacent third and fourth pixels PXL3 and PXL4. Subsequently, a pulse of a third scan signal SC3(n+2) may be simultaneously applied to the vertically adjacent fifth and sixth pixels PXL5 and PXL6.

The fourth shift register SR4 includes a plurality of signal transfer units ST4 connected in a cascaded manner. The fourth shift register SR4 receives a start signal EVST and clocks ECLK1 and ECLK2, and sequentially outputs pulses of the EM signal EM. The clocks ECLK1 and ECLK2 may include two or more shift clocks having different phases. A pulse width of the EM signal EM is set to be wider than one horizontal period, as described with reference to FIG. 3 so that the EM signal EM may be simultaneously applied to the pixels 101 disposed in the plurality of pixel lines. For example, a pulse of an EM signal EM(n−2) may be simultaneously applied to the vertically adjacent first and second pixels PXL1 and PXL2. Subsequently, a pulse of an EM signal EM(n) may be simultaneously applied to the vertically adjacent third and fourth pixels PXL3 and PXL4. Subsequently, a pulse of an EM signal EM(n+2) may be simultaneously applied to the vertically adjacent fifth and sixth pixels PXL5 and PXL6.

The pixel circuit illustrated in FIG. 2 requires five gate signals SC1, SC2, SC3, SC4, and EM. In the present disclosure, as illustrated in FIG. 6, four shift registers SR1, SR2, SR3, and SR4 are used to output the gate signals SC1, SC4, SC2, SC3, and EM, thereby reducing a circuit size of the gate driver 120.

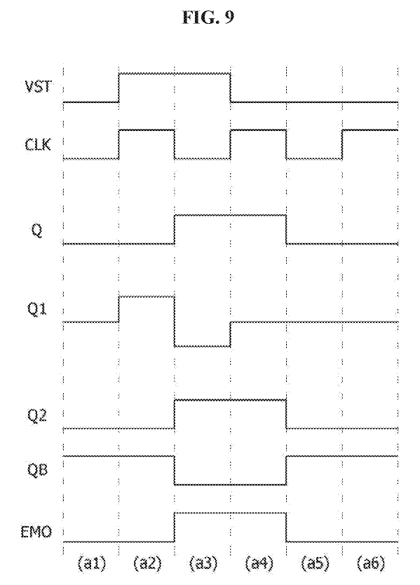

FIG. 8 is a diagram illustrating a first gate driver that outputs gate signals applied to the pixel circuits illustrated in FIGS. 2 and 4. FIG. 9 is a waveform diagram illustrating driving signals applied to the first gate driver illustrated in FIG. 8.

Referring to FIGS. 8 and 9, the first gate driver includes a plurality of switch elements SW1 and SW11 to SW16 for outputting a gate low voltage VGL or a gate high voltage VGH, and a plurality of capacitors CB1, C_ON, and CQB1. The plurality of switch elements SW1 and SW11 to SW16 include a first switch element SW1 and eleventh to sixteenth switch elements SW11 to SW16 and may be implemented as p-channel TFTs. The first switch element SW1 and the eleventh to sixteenth switch elements SW11 to SW16 are turned on in response to a low voltage and are turned off in response to a high voltage.

The thirteenth switch element SW13 is connected between a start signal VST terminal and a Q2 node Q2 and is turned on in response to a low voltage of a clock signal CLK during an a1 period. The thirteenth switch element SW13 applies a low voltage of the start signal VST to the Q2 node Q2.

The first switch element SW1 is connected between the Q2 node Q2 and a Q node Q-node and is always turned on in response to a VGL voltage provided from a VGL voltage terminal connected to a gate of the first switch element SW1 during the a1 period. The low voltage is applied to the Q node Q-node.

The eleventh switch element SW11 is connected between the VGL voltage terminal and an EMO output terminal and is turned on in response to the low voltage applied to the Q node Q-node during the a1 period.

The VGL voltage, which is a low voltage, is output to the EMO output terminal through the eleventh switch element SW11 during the a1 period. The VGL voltage, which is a low voltage, may be referred to as the gate low voltage VEL.

The fourteenth switch element SW14 is connected between a Q1 node Q1 and a VEH voltage terminal and is turned on in response to the low voltage of the start signal VST during the a1 period.

The fifteenth switch element SW15 is connected between a clock signal CLK terminal and a Qb node Qb-node, and, when the fourteenth switch element SW14 is turned on during the a1 period, the fifteenth switch element SW15 is turned off in response to a VEH voltage applied to a gate electrode of the fifteenth switch element SW15.

The sixteenth switch element SW16 is connected between the Qb node Qb-node and the VEH voltage terminal and is turned on in response to the low voltage applied to the Q2 node Q2 during the a1 period. When the sixteenth switch element SW16 is turned on, the VEH voltage is applied to the Qb node Qb-node.

The twelfth switch element SW12 is connected between the EMO output terminal and the VGH voltage terminal and is turned off in response to the VGH voltage, which is a high voltage, applied to the Qb node Qb-node during the a1 period. The VGH voltage, which is a high voltage, may be referred to as the gate high voltage VEH.

The thirteenth switch element SW13 is turned off in response to a high voltage of the clock signal CLK during an a2 period. When the thirteenth switch element SW13 is turned off, the Q node Q-node is floated at the low voltage during the a2 period.

The eleventh switch element SW11 remains in a turned-on state during the a2 period in response to the low voltage, which is floated at the Q node Q-node.

The VGL voltage, which is a low voltage, is output to the EMO output terminal through the eleventh switch element SW11.

The fourteenth switch element SW14 is turned off in response to a high voltage of the start signal VST during the a2 period. The Q1 node Q1 is floated at the high voltage during the a2 period. That is, the Q1 node Q1 is coupled depending on a state of the clock signal CLK by the capacitor C_ON connected between the Q1 node Q1 and the clock signal CLK terminal. For example, during the a2 period, as the high voltage of the clock signal CLK is applied, the Q1 node Q1 is coupled by the capacitor C_ON such that the high voltage is applied to the Q1 node Q1.

The fifteenth switch element SW15 is turned off in response to the high voltage applied to the Q1 node Q1 during the a2 period. The sixteenth switch element SW16 is turned on in response to the low voltage, which is maintained at the Q2 node Q2, during the a2 period. When the sixteenth switch element SW16 is turned on during the a2 period, the VEH voltage, which is a high voltage, is applied to the Qb node Qb-node. The twelfth switch element SW12 is turned off in response to the VEH voltage, which is a high voltage, applied to the Qb node Qb-node during the a2 period.

The thirteenth switch element SW13 is turned on in response to a low voltage of the clock signal CLK during an a3 period. When the thirteenth switch element SW13 is turned on, a high voltage of the start signal VST is applied to the Q node Q-node.

The eleventh switch element SW11 is turned off in response to the high voltage of the start signal VST applied to the Q node Q-node during the a3 period.

The sixteenth switch element SW16 is turned off in response to the high voltage of the start signal VST applied to the Q2 node Q2 during the a3 period.

The Q1 node Q1 is coupled by the capacitor C_ON as the low voltage of the clock signal CLK is applied during the a3 period and is floated at the low voltage.

The fifteenth switch element SW15 is turned on in response to the low voltage applied to the Q1 node Q1 during the a3 period. When the fifteenth switch element SW15 is turned on, the low voltage of the clock signal CLK is applied to the Qb node Qb-node through the fifteenth switch element SW15 during the a3 period.

The twelfth switch element SW12 is turned on in response to the low voltage applied to the Qb node Qb-node during the a3 period. The VEH voltage, which is a high voltage, is output to the EMO output terminal through the twelfth switch element SW12.

The thirteenth switch element SW13 is turned off in response to a high voltage of the clock signal CLK during an a4 period. When the thirteenth switch element SW13 is turned off, the Q node Q-node may maintain the previously applied high voltage of the start signal VST during the a4 period.

The eleventh switch element SW11 is turned off in response to the high voltage of the start signal VST applied to the Q node Q-node during the a4 period.

When the thirteenth switch element SW13 is turned off, the Q2 node Q2 may continuously maintain the previously applied high voltage of the start signal VST during the a4 period.

The sixteenth switch element SW16 is turned off in response to the high voltage of the start signal VST, which is maintained at the Q2 node Q2, during the a4 period.

The fourteenth switch element SW14 is turned on in response to a low voltage of the start signal VST during the a4 period. When the fourteenth switch element SW14 is turned on, the VEH voltage, which is a high voltage, is applied to the Q1 node Q1 during the a4 period.

The fifteenth switch element SW15 is turned off in response to the VEH voltage, which is a high voltage, applied to the Q1 node Q1 during the a4 period. The Qb node Qb-node may maintain the low voltage during the a4 period.

The twelfth switch element SW12 is turned on in response to the low voltage, which is maintained at the Qb node Qb-node, during the a4 period.

The VEH voltage, which is a high voltage, is output to the EMO output terminal through the twelfth switch element SW12.

The thirteenth switch element SW13 is turned on in response to a low voltage of the clock signal CLK during an a5 period. When the thirteenth switch element SW13 is turned on, the low voltage of the start signal VST is applied to the Q node Q-node during the a5 period.

The eleventh switch element SW11 is turned on in response to the low voltage of the start signal VST applied to the Q node Q-node during the a5 period. The VGL voltage, which is a low voltage, is output to the EMO output terminal through the eleventh switch element SW11.

The sixteenth switch element SW16 is turned on in response to the low voltage applied to the Q2 node Q2 during the a5 period. When the sixteenth switch element SW16 is turned on during the a5 period, the VEH voltage, which is a high voltage, is applied to the Qb node Qb-node.

The twelfth switch element SW12 is turned off in response to the VEH voltage, which is a high voltage, applied to the Qb node Qb-node during the a5 period.

The thirteenth switch element SW13 is turned off in response to a high voltage of the clock signal CLK during an a6 period. When the thirteenth switch element SW13 is turned off, the Q node Q-node may maintain the previously applied low voltage of the start signal VST during the a6 period.

The eleventh switch element SW11 remains in the turned-on state in response to the low voltage of the start signal VST applied to the Q node Q-node during the a6 period.

The VGL voltage, which is a low voltage, is output to the EMO output terminal through the eleventh switch element SW11.

When the thirteenth switch element SW13 is turned off, the Q2 node Q2 may maintain the previously applied low voltage of the start signal VST during the a6 period.

The sixteenth switch element SW16 is turned on in response to the low voltage of the start signal VST, which is maintained at the Q2 node Q2, during the a6 period.

The fourteenth switch element SW14 is turned on in response to the low voltage of the start signal VST during the a6 period. When the fourteenth switch element SW14 is turned on, the VEH voltage, which is a high voltage, is applied to the Q1 node Q1 during the a6 period.

The fifteenth switch element SW15 is turned off in response to the VEH voltage, which is a high voltage, applied to the Q1 node Q1 during the a6 period.

When the sixteenth switch element SW16 is turned on, the VEH voltage, which is a high voltage, is applied to the Qb node Qb-node during the a6 period.

The twelfth switch element SW12 is turned on in response to the VEH voltage, which is a high voltage, applied to the Qb node Qb-node during the a6 period.

The above-described first gate driver may generate a pulse of the first scan signal SC1, a pulse of the third scan signal SC3, or a pulse of the fourth scan signal SC4.

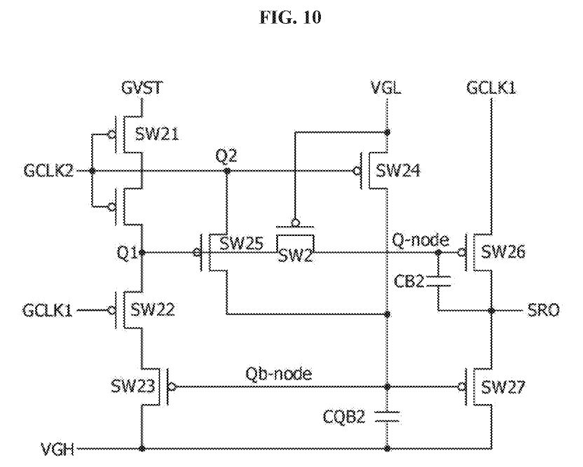

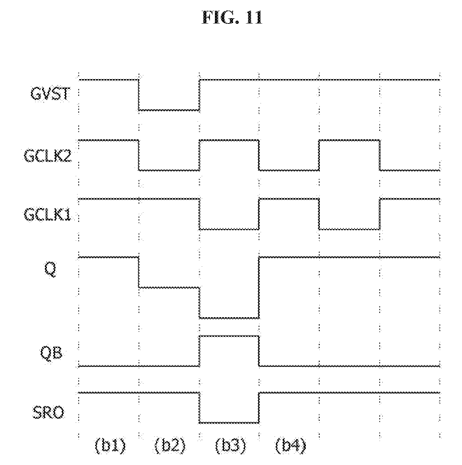

FIG. 10 is a diagram illustrating a second gate driver configured to output gate signals applied to the pixel circuits illustrated in FIGS. 2 and 4. FIG. 11 is a waveform diagram illustrating driving signals applied to the second gate driver illustrated in FIG. 10.

Referring to FIGS. 10 and 11, the second gate driver includes a plurality of switch elements SW2 and SW21 to SW27 and a plurality of capacitors CB2 and CQB2 for outputting a gate low voltage VGL or a gate high voltage VGH. The plurality of switch elements SW2 and SW21 to SW27 include a second switch element SW2 and twenty-first to twenty-seventh switch elements SW21 to SW72 and may be implemented as p-channel TFTs. The second switch element SW2 and the twenty-first to twenty-seventh switch elements SW21 to SW27 are turned on in response to a low voltage and are turned off in response to a high voltage.

The second switch element SW2 is connected between a Q1 node Q1 and a Q node Q-node and is always turned on in response to the gate low voltage VGL during a b1 period.

The twenty-first switch element SW21 is connected between a start signal GVST terminal and the Q1 node Q1 and is turned off in response to a high voltage of a second clock signal GCLK2 during the b1 period.

The twenty-second switch element SW22 is connected between the Q1 node Q1 and the twenty-third switch element SW23 and is turned off in response to a high voltage of a first clock signal GCLK1 during the b1 period.

The twenty-fourth switch element SW24 is connected between a gate low voltage VGL terminal and a Qb node Qb-node and is turned off in response to the high voltage of the second clock signal GCLK2 during the b1 period.

The twenty-fifth switch element SW25 is connected between the Q1 node Q1 and the Qb node Qb-node and is turned off in response to the high voltage maintained in the floating state at the Qb node Qb-node during the b1 period.

The twenty-sixth switch element SW26 is connected between a first clock signal GCLK1 terminal and an SRO output terminal and is turned off in response to the high voltage maintained in the floating state at the Q node Q-node during the b1 period.

The twenty-third switch element SW23 is connected between the twenty-second switch element SW22 and a gate high voltage VGH terminal and is turned on in response to the low voltage maintained in the floating state at the Qb node Qb-node during the b1 period.

The twenty-seventh switch element SW27 is connected between the SRO output terminal and the gate high voltage VGH terminal and is turned on in response to the low voltage maintained in the floating state at the Qb node Qb-node during the b1 period.

The gate high voltage VGH is output to the SRO output terminal through the twenty-seventh switch element SW27 during the b1 period. Accordingly, the SRO output terminal may maintain the high voltage.

The twenty-first switch element SW21 and the twenty-fourth switch element SW24 are turned on in response to a low voltage of the second clock signal GCLK2 during a b2 period.

When the twenty-first switch element SW21 is turned on, a low voltage of a start signal GVST is applied during the b2 period. The Q node Q-node may be pre-charged to the low voltage.

The twenty-sixth switch element SW26 is turned on in response to the low voltage pre-charged at the Q node Q-node during the b2 period.

The high voltage of the first clock signal GCLK1 is output to the SRO output terminal through the twenty-sixth switch element SW26 during the b2 period.

When the twenty-fourth switch element SW24 is turned on, the gate low voltage VGL is applied to the Qb node Qb-node during the b2 period.

The twenty-seventh switch element SW27 is turned on in response to the gate low voltage VGL applied to the Qb node Qb-node.

The gate high voltage VGH is output to the SRO output terminal through the twenty-seventh switch element SW27 during the b2 period. Accordingly, the SRO output terminal may maintain the high voltage.

The twenty-fifth switch element SW25 is turned on in response to the low voltage applied to the Q node Q-node during the b2 period.

The low voltage of the second clock signal GCLK2 is applied to the Qb node Qb-node through the twenty-fifth switch element SW25 during the b2 period. The Q node Q-node and the Qb node Qb-node maintain the low voltage state during the b2 period. Accordingly, the first clock signal GCLK1 may be connected to the gate high voltage VGH.

The twenty-first switch element SW21 and the twenty-fourth switch element SW24 are turned off in response to a high voltage of the second clock signal GCLK2 during a b3 period.

The twenty-second switch element SW22 is turned on in response to a low voltage of the first clock signal GCLK1 during the b3 period.

The twenty-fifth switch element SW25 is turned on in response to the low voltage maintained at the Q node Q-node during the b3 period.

When the twenty-fifth switch element SW25 is turned on, the high voltage of the second clock signal GCLK2 is applied to the Qb node Qb-node during the b3 period. Accordingly, the Qb node Qb-node enters a high voltage state.

The twenty-third switch element SW23 and the twenty-seventh switch element SW27 are turned off in response to the high voltage of the second clock signal GCLK2 applied to the Qb node Qb-node during the b3 period.

The twenty-sixth switch element SW26 is turned on in response to the low voltage maintained at the Q node Q-node during the b3 period.

The low voltage of the first clock signal GCLK1 is output to the SRO output terminal through the twenty-sixth switch element SW26 during the b3 period. The SRO output terminal may output the low voltage of the first clock signal GCLK1 instead of the high voltage of the first clock signal GCLK1.

At this point, the Q node Q-node may be coupled by the capacitor CB2.

The twenty-first switch element SW21 and the twenty-fourth switch element SW24 are turned on in response to a low voltage of the second clock signal GCLK2 during a b4 period.

The twenty-second switch element SW22 is turned off in response to a high voltage of the first clock signal GCLK1 during the b4 period.

When the twenty-first switch element SW21 is turned on, a high voltage of the start signal GVST is applied to the Q node Q-node during the b4 period. The Q node Q-node enters a high voltage state.

The twenty-sixth switch element SW26 is turned off in response to the high voltage of the start signal GVST applied to the Q node Q-node during the b4 period.

The twenty-fourth switch element SW24 is turned on in response to the gate low voltage VGL during the b4 period.

When the twenty-fourth switch element SW24 is turned on, the gate low voltage VGL is applied to the Qb node Qb-node.

The twenty-third switch element SW23 and the twenty-seventh switch element SW27 are turned on in response to the gate low voltage VGL applied to the Qb node Qb-node during the b4 period.

The gate high voltage VGH is output to the SRO output terminal through the twenty-seventh switch element SW27 during the b4 period. The SRO output terminal may output the gate high voltage VGH.

The above-described second gate driver may generate a pulse of the second scan signal SC2.

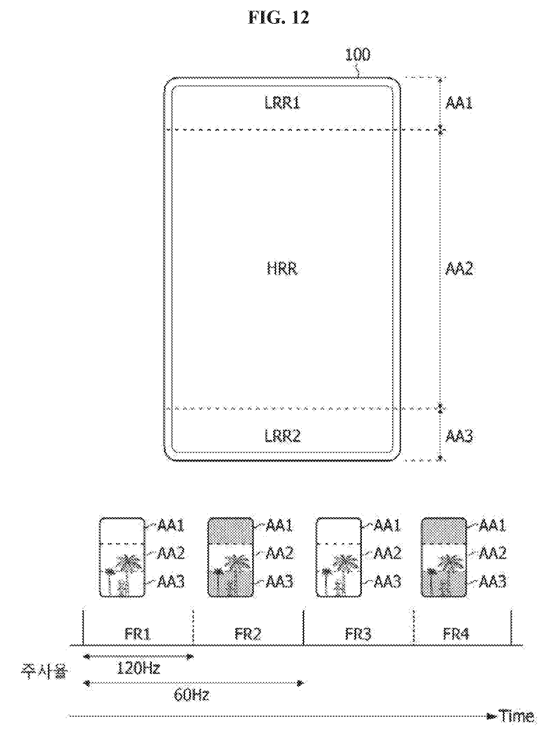

FIG. 12 is a diagram illustrating an example of the display panel driven at multiple frequencies within one frame period.

Referring to FIG. 12, the display area AA of the display panel 100 may be divided into a plurality of sub-display areas AA1, AA2, and AA3. In the display panel 100, the sub-display areas AA1, AA2, and AA3 are not physically separated from each other, but are local pixel areas in which driving frequencies of pixels are independently controlled. The sub-display areas AA1, AA2, and AA3 include pixels having substantially the same structure and signal wirings. The sub-display areas AA1, AA2, and AA3 are local areas in which driving frequencies of pixels are different when the pixels are driven at a variable refresh rate.

The timing controller 130 may control each of the sub-display areas AA1, AA2, and AA3 as a refresh area or a skip area. The timing controller 130 may determine a refresh rate of an input image in real time and may vary a size and a position of each of the sub-display areas AA1, AA2, and AA3 for each frame period. Upper and lower portions of the input image may be reproduced in first and third sub-display areas AA1 and AA3, respectively, at a low refresh rate LRR, for example, 60 Hz. The first and third sub-display areas AA1 and AA3 may be referred to as second refresh rate areas. A central portion of the input image may be reproduced in a second sub-display area AA2 at a high refresh rate HRR, for example, 120 Hz. The second sub-display area AA2 may be referred to as a first refresh rate area. The refresh rates of the first sub-display area AA1 and the third sub-display area AA3 may be the same as or different from each other.

In the example of FIG. 12, the pixels of the first sub-display area AA1 are driven at a refresh driving frequency in first and third frame periods FR1 and FR3, whereas the pixels are driven at a skip-frame frequency during second and fourth frame periods FR2 and FR4. The pixels of the second sub-display area AA2 may be driven at the refresh driving frequency in every frame period during the first to fourth frame periods FR1, FR2, FR3, and FR4.

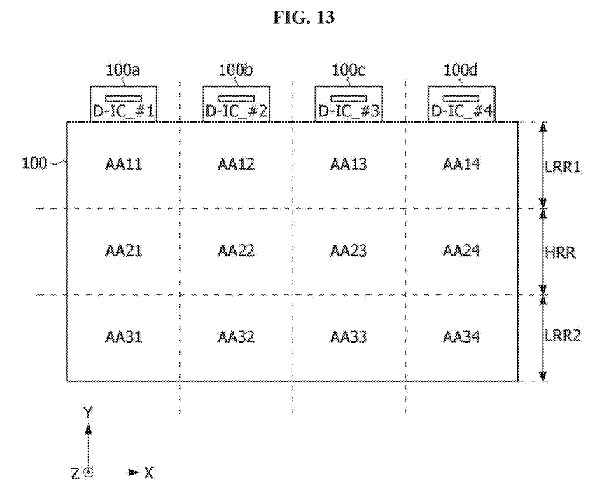

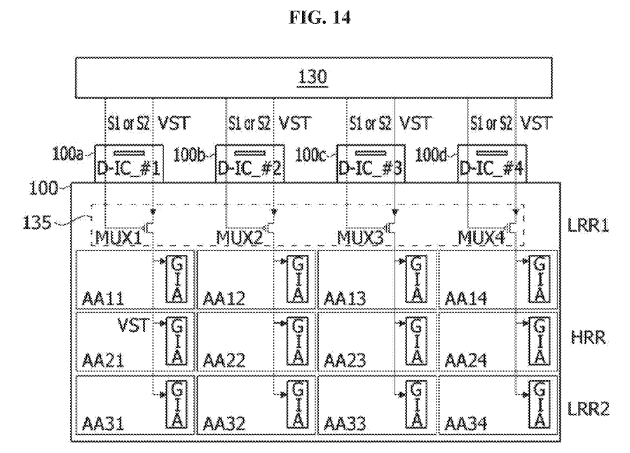

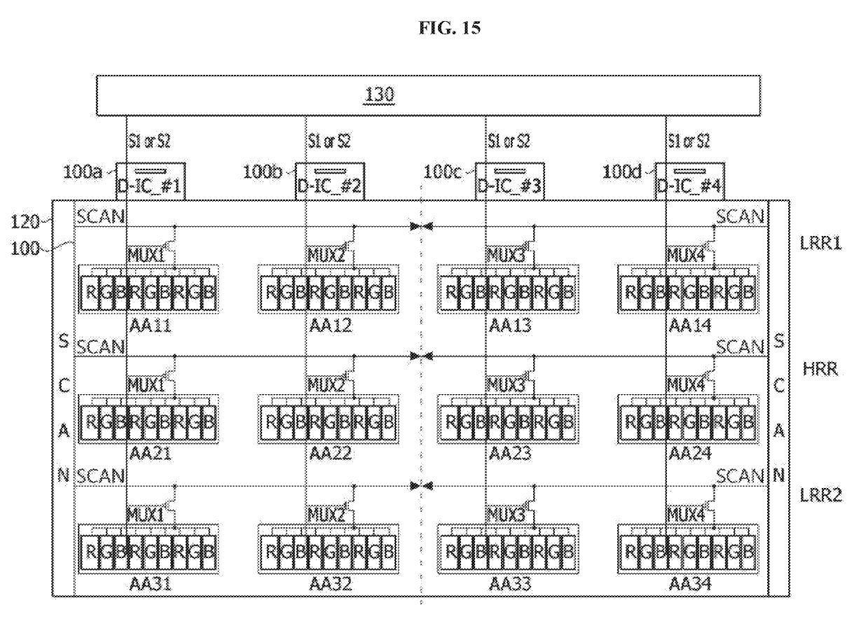

FIG. 13 is a diagram illustrating an example of the display panel driven at multiple frequencies based on a plurality of D-ICs within one frame period, FIG. 14 is a diagram illustrating an example of the signal selector according to the implementation of the present disclosure, and FIG. 15 is a diagram illustrating another example of the signal selector according to the implementation of the present disclosure.

Referring to FIG. 13, the data driver 110 (see FIG. 1) may include one or more D-ICs. For example, the one or more D-ICs may include n D-ICs arranged as a first D-IC 100a, a second D-IC 100b, up to an n^{th} D-IC 100n. Each of the first to n^{th} D-ICs 100a to 100n may be electrically connected to the data lines and may output data voltages corresponding to pixel data of an input image. In FIG. 13, for convenience of description, an example is described with four D-ICs arranged as a first D-IC 100a, a second D-IC 100b, a third D-IC 100c, and a fourth D-IC 100d.

FIG. 12 illustrates that the display area AA of the display panel 100 is divided into the plurality of sub-display areas AA1, AA2, and AA3 in a vertical direction Y. However, the present disclosure is not limited thereto, and the display area AA of the display panel 100 may be divided into a plurality of sub-display areas in a horizontal direction X. Here, the plurality of sub-display areas may be represented as sub-display areas from an eleventh sub-display area AA11 to a thirty-fourth sub-display area AA34.

The first D-IC 100a is electrically connected to the data lines disposed in the eleventh sub-display area AA11, the twenty-first sub-display area AA21, and the thirty-first sub-display area AA31 that are arranged in the vertical direction. The second D-IC 100b is electrically connected to the data lines disposed in the twelfth sub-display area AA12, the twenty-second sub-display area AA22, and the thirty-second sub-display area AA32 that are arranged in the vertical direction. The third D-IC 100c is electrically connected to the data lines disposed in the thirteenth sub-display area AA13, the twenty-third sub-display area AA23, and the thirty-third sub-display area AA33 that are arranged in the vertical direction. The fourth D-IC 100d is electrically connected to the data lines disposed in the fourteenth sub-display area AA14, the twenty-fourth sub-display area AA24, and the thirty-fourth sub-display area AA34 that are arranged in the vertical direction.

The above-described sub-display areas from the eleventh sub-display area AA11 to the thirty-fourth sub-display area AA34 include pixels and signal wirings having substantially the same structure. The sub-display areas from the eleventh sub-display area AA11 to the thirty-fourth sub-display area AA34 may be local pixel areas having different pixel driving frequencies when the pixels are driven at the variable refresh rate.

For example, the timing controller 130 may determine a refresh rate of an input image and may control positions of the plurality of sub-display areas to be varied in each frame period. For example, the timing controller 130 may control the signal selector 135 to selectively apply the start signal VST to each of the sub-display areas from the eleventh sub-display area AA11 to the thirty-fourth sub-display area AA34 driven at the variable refresh rate. That is, the timing controller 130 may control the signal selector 135 such that a scan signal Scan is output only to the first refresh rate area, which is a sub-display area requiring the high refresh rate HRR, on the same horizontal line and the scan signal Scan is not output to the second refresh rate area, which is a sub-display area requiring the low refresh rate LRR, thereby enabling the D-ICs 100a, 100b, 100c, and 100d to be turned on or off individually.

As illustrated in FIGS. 13 and 14, the timing controller 130 may control the signal selector 135 such that the scan signal Scan is output only to the twenty-third sub-display area AA23, which requires high refresh rate HRR driving, on the same horizontal line and the scan signal Scan is not output to the remaining sub-display areas in which low refresh rate LRR driving is possible, thereby turning off the remaining D-ICs 100a, 100b, and 100d other than the third D-IC 100c. For example, the twenty-third sub-display area AA23 may be the first refresh rate area, and the remaining sub-display areas other than the twenty-third sub-display area AA23 may be the second refresh rate areas.

The signal selector 135 may include first to n^{th} signal selectors MUX1 to MUXn. In FIG. 14, for convenience of description, the first to fourth signal selectors MUX1 to MUX4 will be mainly described. The signal selector 135 may be formed as multiplexers (MUXs) or switch elements. For example, the switch elements may be implemented as p-channel TFTs. The switch elements are turned on in response to a low voltage, and turned off in response to a high voltage.

The signal selector 135 may be disposed between the timing controller 130 and a gate in array (GIA) circuit unit included in the pixel array.

For example, the first signal selector MUX1 may operate to control whether the start signal VST is applied to each of the eleventh sub-display area AA11, the twenty-first sub-display area AA21, and the thirty-first sub-display area AA31 in response to a first signal S1 or a second signal S2 provided from the timing controller 130. The second signal selector MUX2 may operate to control whether the start signal VST is applied to each of the twelfth sub-display area AA12, the twenty-second sub-display area AA22, and the thirty-second sub-display area AA32 in response to the first signal S1 or the second signal S2 provided from the timing controller 130. The third signal selector MUX3 may operate to control whether the start signal VST is applied to each of the thirteenth sub-display area AA13, the twenty-third sub-display area AA23, and the thirty-third sub-display area AA33 in response to the first signal S1 or the second signal S2 provided from the timing controller 130. The fourth signal selector MUX4 may operate to control whether the start signal VST is applied to each of the fourteenth sub-display area AA14, the twenty-fourth sub-display area AA24, and the thirty-fourth sub-display area AA34 in response to the first signal S1 or the second signal S2 provided from the timing controller 130.

Here, the first signal S1 may have a low voltage, and the second signal S2 may have a high voltage. For example, the switch element is turned on in response to the first signal S1 having a low voltage, whereas the switch element is turned off in response to the second signal S2 having a high voltage.

When the timing controller 130 determines that a refresh rate of an input image is higher than or equal to a reference refresh rate, the timing controller 130 may provide the first signal S1 to the signal selector 135. When the timing controller 130 determines that the refresh rate of the input image is lower than the reference refresh rate, the timing controller 130 may provide the second signal S2 to the signal selector 135.

For example, when the second signal S2 is supplied from the timing controller 130, the first signal selector MUX1 is turned off in response to the second signal S2. A start signal VST line is electrically disconnected by the first signal selector MUX1 that is turned off. As the start signal VST line is electrically disconnected, the start signal VST output from the timing controller 130 cannot be transmitted to the GIA circuit unit through the start signal VST line. The start signal VST line may be a line through which the start signal VST output from the timing controller 130 is supplied to the GIA circuit unit.

The GIA circuit unit may not receive the start signal VST from the timing controller 130 and thus may not respond to the start signal VST and may not generate a scan signal. Accordingly, the GIA circuit unit cannot output the scan signal to the eleventh sub-display area AA11, which is the second refresh rate area to which a refresh rate lower than the reference refresh rate is applied. Since the second signal selector MUX2 and the fourth signal selector MUX4 have substantially the same configuration as the first signal selector MUX1 and operate in the same manner, a description thereof will be omitted or may be briefly provided.

In contrast, when the first signal S1 is supplied from the timing controller 130, the third signal selector MUX3 is turned on in response to the first signal S1. The start signal VST line is electrically connected by the third signal selector MUX3 that is turned on. As the start signal VST line is electrically connected, the start signal VST output from the timing controller 130 may be transmitted to the GIA circuit unit through the start signal VST line.

The GIA circuit unit may generate the scan signal in response to the transmitted start signal VST. Accordingly, the GIA circuit unit may output the scan signal to the twenty-third sub-display area AA23, which is the first refresh rate area to which a refresh rate higher than the reference refresh rate is applied.

As described above, in a GIA structure, the present disclosure may control whether the GIA circuit unit generates the scan signal SCAN by providing the signal selector configured to determine whether to input the start signal VST to the GIA circuit unit for each of the first to fourth D-ICs 100a to 100d.

The present disclosure may drive each of the sub-display areas arranged on the same horizontal line at the variable refresh rate by forming the signal selector 135 between the timing controller 130 and the GIA circuit unit and controlling whether the scan signal SCAN is generated.

That is, the present disclosure may reduce power consumption by turning on only the D-IC related to the sub-display area driven at the high refresh rate and turning off the D-IC related to the sub-display area driven at the low refresh rate.

As illustrated in FIGS. 13 and 15, the timing controller 130 may control the signal selector 135 such that the scan signal Scan is output only to the twenty-third sub-display area AA23, which requires high refresh rate HRR driving, on the same horizontal line and the scan signal Scan is not output to the remaining sub-display areas in which low refresh rate LRR driving is possible, thereby turning off the remaining D-ICs 100a, 100b, and 100d other than the third D-IC 100c.

The signal selector may be disposed between the gate lines, which are connected to the gate drivers 120 disposed in the non-display areas NA on both sides of the display panel 100, and the pixels.

For example, the first signal selector MUX1 may operate to control whether the scan signal is applied to each of the pixels of the eleventh sub-display area AA11, the pixels of the twenty-first sub-display area AA21, and the pixels of the thirty-first sub-display area AA31 in response to the first signal S1 or the second signal S2 provided from the timing controller 130. The second signal selector MUX2 may operate to control whether the scan signal is applied to each of the pixels of the twelfth sub-display area AA12, the pixels of the twenty-second sub-display area AA22, and the pixels of the thirty-second sub-display area AA32 in response to the first signal S1 or the second signal S2 provided from the timing controller 130. The third signal selector MUX3 may operate to control whether the scan signal is applied to each of the pixels of the thirteenth sub-display area AA13, the pixels of the twenty-third sub-display area AA23, and the pixels of the thirty-third sub-display area AA33 in response to the first signal S1 or the second signal S2 provided from the timing controller 130. The fourth signal selector MUX4 may operate to control whether the scan signal is applied to each of the pixels of the fourteenth sub-display area AA14, the pixels of the twenty-fourth sub-display area AA24, and the pixels of the thirty-fourth sub-display area AA34 in response to the first signal S1 or the second signal S2 provided from the timing controller 130.

The timing controller 130 may provide the first signal S1 to the signal selector 135 when it is determined that a refresh rate of an input image is higher than the reference refresh rate. The timing controller 130 may provide the second signal S2 to the signal selector 135 when it is determined that a refresh rate of an input image is lower than the reference refresh rate.

For example, when the second signal S2 is supplied from the timing controller 130, the first signal selector MUX1 is turned off in response to the second signal S2. As the first signal selector MUX1 is turned off, a scan signal output from the gate driver 120 is blocked by the first signal selector MUX1 and thus may not be provided to the pixels of the eleventh sub-display area AA11, which is the second refresh rate area to which a refresh rate lower than the reference refresh rate is applied. Since the second signal selector MUX2 and the fourth signal selector MUX4 have substantially the same configuration as the first signal selector MUX1 and operate in the same manner, a description thereof will be omitted or may be briefly provided.

In contrast, when the first signal S1 is supplied from the timing controller 130, the third signal selector MUX3 is turned on in response to the first signal S1. As the third signal selector MUX3 is turned on, a scan signal output from the gate driver 120 may be provided, through the third signal selector MUX3, to the pixels of the twenty-third sub-display area AA23, which is the first refresh rate area to which a refresh rate higher than the reference refresh rate is applied.

As described above, in a structure in which the gate driver 120 is disposed at edges and the scan signals Scan are supplied from a left edge and a right edge, the present disclosure may classify the pixels PXL according to positions of the first to fourth D-ICs 100a to 100d and may form the first to fourth signal selectors MUX1 to MUX4, which are included in the signal selector 135, to correspond to the pixels PXL according to the respective positions of the first to fourth D-ICs 100a to 100d.

Accordingly, in the present disclosure, whether the scan signal is supplied to the pixels PXL may be controlled by using the signal selector 135, and thus each of the sub-display areas arranged on the same horizontal line may be driven at the variable refresh rate.

That is, according to the present disclosure, power consumption may be reduced by turning on only the D-IC related to the sub-display area driven at the high refresh rate and turning off the D-IC related to the sub-display area driven at the low refresh rate.

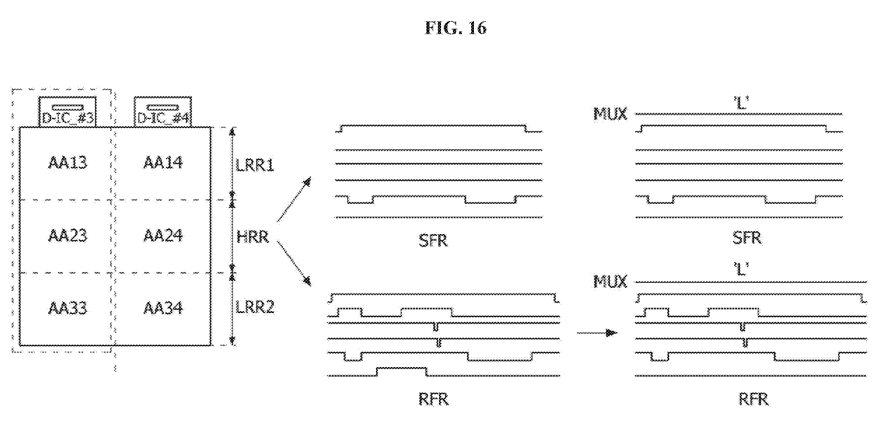

FIGS. 16-18 are waveform diagrams illustrating driving signals driven during the refresh frame period and the skip frame period in accordance with operation of the signal selector according to the implementation of the present disclosure.

Referring to FIGS. 13 and 16-18, the timing controller 130 may control each of the sub-display areas from the eleventh sub-display area AA11 to the thirty-fourth sub-display area AA34 to operate as the refresh area or the skip area for each of the first to fourth D-ICs 100a to 100d.

The timing controller 130 may determine a refresh rate of an input image in real time and may vary, for each frame period, operation of each of the sub-display areas from the eleventh sub-display area AA11 to the thirty-fourth sub-display area AA34 for each of the first to fourth D-ICs 100a to 100d.

For each of the first to fourth D-ICs 100a to 100d, an upper portion of an input image may be reproduced at the low refresh rate LRR1, for example, 60 Hz, in the eleventh to fourteenth sub-display areas AA11 to AA14.

For each of the first to fourth D-ICs 100a to 100d, a central portion of the input image may be reproduced at the high refresh rate HRR, for example,120 Hz, in the twenty-first to twenty-fourth sub-display areas AA21 to AA24

For each of the first to fourth D-ICs 100a to 100d, a lower portion of the input image may be reproduced at the low refresh rate LRR1, for example, 60 Hz, in the thirty-first to thirty-fourth sub-display areas AA31 to AA34.

As illustrated in FIG. 16, when the timing controller 130 determines, in real time, a refresh rate of an input image and determines that high refresh rate HRR driving is required for the twenty-third sub-display area AA23 connected to the third D-IC 100c in the central portion of the input image, the timing controller 130 may supply the first signal S1 having a low voltage to the third signal selector MUX3.

The third signal selector MUX3 may be turned on in response to the first signal S1 having a low voltage. When the third signal selector MUX3 is turned on and outputs a scan signal, the third D-IC 100c may also operate accordingly.

The pixels of the thirteenth sub-display area AA13 driven at the low refresh rate LRR1 may be driven at a skip-frame frequency during a first frame period due to the scan signal being provided through the turned-on third signal selector MUX3.

The pixels of the twenty-third sub-display area AA23 driven at the high refresh rate HRR may be driven at a refresh frame frequency during the first frame period due to the scan signal being provided through the turned-on third signal selector MUX3.

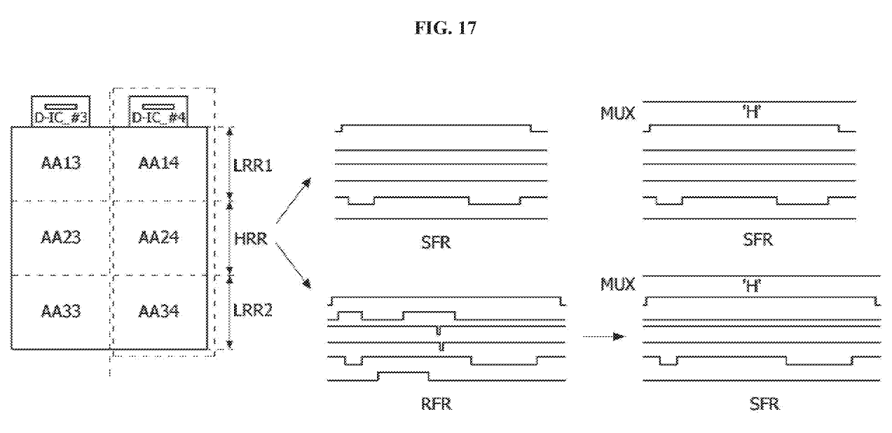

As illustrated in FIG. 17, when the timing controller 130 determines, in real time, a refresh rate of an input image and determines that high refresh rate HRR driving is not required for the twenty-fourth sub-display area connected to the fourth D-IC 100d in the central portion of the input image, the timing controller 130 may supply the second signal S2 having a high voltage to the fourth signal selector MUX4.

The fourth signal selector MUX4 may be turned off in response to the second signal S2 having a high voltage. When the fourth signal selector (MUX4) is turned off and the scan signal is blocked, the fourth D-IC 100d may also be turned off (or may be skipped from operation) accordingly.

The pixels of the fourteenth sub-display area AA14 driven at the low refresh rate LRR1 may be driven at the skip-frame frequency during the first frame period due to the scan signal being blocked by the turned-off fourth signal selector MUX4.

The pixels of the twenty-fourth sub-display area AA24 driven at the low refresh rate LRR may be driven during the first frame period while being changed from the refresh frame frequency to the skip-frame frequency due to the scan signal being blocked by the turned-off fourth signal selector MUX4.

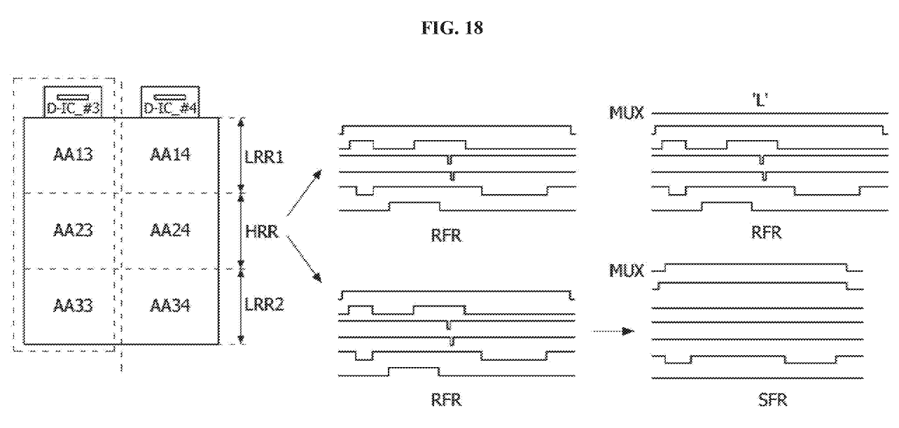

As illustrated in FIG. 18, when the timing controller 130 determines, in real time, a refresh rate of an input image and determines that high refresh rate HRR driving is required for the twenty-third sub-display area AA23 connected to the third D-IC 100c in the central portion of the input image, the timing controller 130 may supply the first signal S1 having a low voltage to the third signal selector MUX3.

In contrast, when the timing controller 130 determines, in real time, a refresh rate of an input image and determines that high refresh rate HRR driving is not required for the thirty-third sub-display area AA33, which is connected to the third D-IC 100c, in the lower portion of the input image, the timing controller 130 may supply the second signal S2 having a high voltage to the third signal selector MUX3.

That is, the timing controller 130 may determine a refresh rate of an input image in real time and may supply different signals to the third signal selector MUX3 for the twenty-third sub-display area AA23 connected to the third D-IC 100c and the thirty-third sub-display area AA33 connected to the third D-IC, based on the determined result.

For example, when it is determined that the pixels of the twenty-third sub-display area AA23 are driven at the high refresh rate HRR, the timing controller 130 may supply the first signal S1 to the third signal selector MUX3 and may control the scan signal to be output in response thereto, thereby driving the pixels of the twenty-third sub-display area AA23 at the refresh frame frequency during the first frame period.

In contrast, when it is determined that the pixels of the thirty-third sub-display area AA33 are driven at the low refresh rate LRR, the timing controller 130 may supply the second signal S2 to the third signal selector MUX3 and may control the scan signal to be blocked in response thereto, thereby driving the pixels of the thirty-third sub-display area AA33 at the skip-frame frequency during the first frame period.

According to one or more implementations of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display device according to one or more implementations of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

According to the present disclosure, power consumption can be reduced by turning on only D-ICs associated with a sub-display area driven at a high refresh rate and turning off D-ICs associated with a sub-display area driven at a low refresh rate.

Although the implementations of the present disclosure have been described in more detail with reference to the accompanying drawings, the present disclosure is not limited thereto and may be embodied in many different forms without departing from the technical concept of the present disclosure. Therefore, the implementations disclosed in the present disclosure are provided for illustrative purposes only and are not intended to limit the technical concept of the present disclosure. The scope of the technical concept of the present disclosure is not limited thereto. Therefore, it should be understood that the above-described implementations are illustrative in all aspects and do not limit the present disclosure.

What is claimed is:

1. A display device comprising:
a display panel in which a plurality of data lines, a plurality of gate lines, a plurality of power lines, and a plurality of pixels are disposed;
a data driver circuit electrically connected to the plurality of data lines;
a gate driver circuit electrically connected to the plurality of gate lines;
a timing controller circuit configured to control the data driver circuit and the gate driver circuit; and
a signal selector circuit disposed between the timing controller circuit and the gate driver circuit,
wherein the timing controller circuit is configured to determine a refresh rate of an input image and to control positions of the plurality of pixels to be varied for each frame period, and
wherein the signal selector circuit is configured to select whether to apply a start signal provided from the timing controller circuit, and wherein the signal selector circuit is configured to control the gate driver circuit to output a scan signal to a first refresh rate area to which a refresh rate higher than or equal to a reference refresh rate is applied, during a same one horizontal period (1H) within the frame period.

2. The display device of claim 1, wherein the signal selector circuit is configured to control the gate driver circuit so as not to output the scan signal to a second refresh rate area to which a refresh rate lower than the reference refresh rate is applied.

3. The display device of claim 2, wherein the timing controller circuit is configured to (i) provide a first signal to the signal selector circuit based on a determination that the refresh rate of the input image is higher than or equal to the reference refresh rate, and (ii) provide a second signal different from the first signal to the signal selector circuit based on a determination that the refresh rate of the input image is lower than the reference refresh rate.

4. The display device of claim 3, wherein, based on the first signal being provided from the timing controller circuit, the signal selector circuit is turned on in response to the first signal and applies the start signal to the gate driver circuit so that the scan signal is output to the first refresh rate area.

5. The display device of claim 4, wherein, based on the second signal being provided from the timing controller circuit, the signal selector circuit is turned off in response to the second signal and the signal selector circuit blocks the start signal from being applied to the gate driver circuit so that the scan signal is not output to the second refresh rate area.

6. The display device of claim 1, wherein the data driver circuit includes n data integrated circuits (D-ICs) including a first D-IC to an n^{th} D-IC,
wherein the signal selector circuit includes n signal selector circuits including a first signal selector circuit to an n^{th} signal selector circuit, and
wherein the first signal selector circuit to the n^{th} signal selector circuit correspond to the first D-IC to the n^{th} D-IC, respectively.

7. The display device of claim 6, wherein, based on a first signal being provided from the timing controller circuit to one of the n signal selector circuits, only a D-IC associated with the signal selector circuit to which the first signal is provided is driven, and remaining D-ICs among the n D-ICs are not driven.

8. The display device of claim 7, wherein each of the n signal selector circuits is implemented as a p-channel thin-film transistor (TFT),
wherein the first signal has a low voltage, and
wherein a second signal has a high voltage.

9. A display device comprising:
a display panel in which a plurality of data lines, a plurality of gate lines, a plurality of power lines, and a plurality of pixels are disposed;
a data driver circuit electrically connected to the plurality of data lines;
a gate driver circuit electrically connected to the plurality of gate lines;
a timing controller circuit configured to control the data driver circuit and the gate driver circuit; and
a signal selector circuit disposed between the plurality of gate lines and the plurality of pixels,
wherein the timing controller circuit is configured to determine a refresh rate of an input image, and to control positions of the plurality of pixels to be varied for each frame period, and
wherein the signal selector circuit is configured to select whether to output a scan signal provided from the gate driver circuit, and wherein the signal selector circuit is configured to perform control such that the scan signal is output to a first refresh rate area to which a refresh rate higher than or equal to a reference refresh rate is applied, during a same one horizontal period (1H) within the frame period.

10. The display device of claim 9, wherein the signal selector circuit is configured to perform control such that the scan signal is not output to a second refresh rate area to which a refresh rate lower than the reference refresh rate is applied.

11. The display device of claim 10, wherein the timing controller circuit is configured to (i) provide a first signal to the signal selector circuit based on a determination that the refresh rate of the input image is higher than or equal to the reference refresh rate, and (ii) provide a second signal different from the first signal to the signal selector circuit based on a determination that the refresh rate of the input image is lower than the reference refresh rate.

12. The display device of claim 11, wherein, based on the first signal being provided from the timing controller circuit, the signal selector circuit is turned on in response to the first signal and performs control such that the scan signal is output to the first refresh rate area.

13. The display device of claim 12, wherein, based on the second signal being provided from the timing controller circuit, the signal selector circuit is turned off in response to the second signal and performs control such that the scan signal is not output to the second refresh rate area.

14. The display device of claim 9, wherein the data driver circuit includes n data integrated circuits (D-ICs) including a first D-IC to an n^{th} D-IC,
wherein the signal selector circuit includes n signal selector circuits including a first signal selector circuit to an n^{th} signal selector circuit, and
wherein the first signal selector circuit to the n^{th} signal selector circuit correspond to the first D-IC to the n^{th} D-IC, respectively.

15. The display device of claim 14, wherein, based on a first signal being provided from the timing controller circuit to one of the n signal selector circuits, only a D-IC associated with the signal selector circuit to which the first signal is provided is driven, and remaining D-ICs among the n D-ICs are not driven.
